(19) United States
(12) Patent Application Publication
(10) Pub. No.: US 2025/0309483 A1
(43) Pub. Date: Oct. 2, 2025

(54) BATTERY MODULE INCLUDING BUSBAR HOLE

(71) Applicant: SK On Co., Ltd., Seoul (KR)

(72) Inventors: Jung Kwan LEE, Daejeon (KR); Seung Il KWAK, Daejeon (KR); Ha Neul CHOI, Daejeon (KR)

(21) Appl. No.: 19/052,209

(22) Filed: Feb. 12, 2025

(30) Foreign Application Priority Data
Mar. 29, 2024 (KR) 10-2024-0043685

(51) Int. Cl. H01M 50/503; H01M 10/613; H01M 10/6551; H01M 10/658; H01M 50/204

(52) U.S. Cl. CPC H01M 50/503; H01M 10/613; H01M 10/6551; H01M 10/658; H01M 50/204

(57) ABSTRACT

A battery module includes a housing including an accommodation space in which a cooling fluid is accommodated; a cell assembly including a plurality of battery cells stacked in a first direction in the accommodation space and each including a lead tab; and a busbar assembly disposed to face the cell assembly in the accommodation space, and including a plurality of busbars electrically connected to the plurality of battery cells, and a support plate supporting the busbar, wherein the busbar includes a plurality of slit holes into which the lead tab is inserted; and at least one busbar hole disposed between the plurality of slit holes and allowing cooling fluid to flow therethrough.

### CROSS-REFERENCE TO RELATED APPLICATION(S)

This application claims benefit of priority to Korean Patent Application No. 10-2024-0043685 filed on Mar. 29, 2024 in the Korean Intellectual Property Office, the disclosure of which is incorporated herein by reference in its entirety.

### TECHNICAL FIELD

The present disclosure generally relates to a battery module including a busbar hole.

### BACKGROUND

Unlike a primary battery, a secondary battery may be easily charged and discharged, such that a secondary battery has been widely used as a power source for various mobile devices and electric vehicles.

The secondary battery may include battery cells in which an electrode assembly formed by stacking a positive electrode plate, a negative electrode plate, and a separator or by winding the components in a roll shape is accommodated in a case. A plurality of battery cells may be stacked in a predetermined direction and may be accommodated in a battery module or a battery pack.

A battery cell may generate heat due to an electrochemical reaction while being charged and discharged. In case heat is not discharged, heat may continuously accumulate in an internal space of the battery module or the battery pack, which may result in reduced performance or a risk of fire.

Thus, research on a structure in which a battery cell may be cooled more effectively may be necessary.

### SUMMARY

An example embodiment of the present disclosure is to prevent a busbar from being overcooled by cooling fluid.

An example embodiment of the present disclosure is to allow cooling fluid to smoothly pass through a busbar.

The present disclosure may be widely applied in green technology fields such as an electric vehicle, a battery charging station, and a solar power generation and wind power generation using batteries. Also, the present disclosure may be used in an eco-friendly electric vehicle, a hybrid vehicle, or the like, to prevent climate change by suppressing air pollution and greenhouse gas emissions.

According to an aspect of the present disclosure, a battery module includes a housing including an accommodation space in which a cooling fluid is accommodated; a cell assembly including a plurality of battery cells stacked in a first direction in the accommodation space and each including a lead tab; and a busbar assembly disposed to face the cell assembly in the accommodation space, and including a plurality of busbars electrically connected to the plurality of battery cells, and a support plate supporting the busbar, wherein the busbar includes a plurality of slit holes into which the lead tab is inserted; and at least one busbar hole disposed between the plurality of slit holes and allowing cooling fluid to flow therethrough.

The cell assembly includes at least one of a cell pad disposed between the plurality of battery cells and preventing heat transfer between the plurality of adjacent battery cells or a cooling fin provided to exchange heat with the plurality of adjacent battery cells, and the busbar hole is disposed to face at least one of the cell pad or the cooling fin.

The battery module may further include an end plate disposed to face the cell assembly with the busbar assembly therebetween, and including at least one plate hole through which cooling fluid passes, wherein a center of the busbar hole is spaced apart from a center of the plate hole by a predetermined distance in the first direction so as to not overlap the plate hole.

The support plate may include at least one pass hole disposed between the plurality of busbars and allowing cooling fluid to pass therethrough.

The battery module may further include an end plate disposed to face the cell assembly with the busbar assembly therebetween, and including at least one plate hole through which cooling fluid passes, wherein the pass hole is disposed such that at least a portion of the pass hole overlaps the plate hole in the second direction perpendicular to the first direction.

The busbar hole and the pass hole may be disposed alternately in the first direction.

The busbar assembly may further include an insulating panel disposed between the support plate and the cell assembly, and the insulating panel includes at least one panel hole communicating with the busbar hole in the second direction facing the cell assembly.

The support plate may include at least one support hole communicating with the busbar hole, and the support hole may be disposed parallel to the busbar hole such that at least a portion of the support hole overlaps the busbar hole in the second direction.

The busbar hole may be disposed parallel to the panel hole such that at least a portion of the busbar hole overlaps in the second direction.

The busbar hole may be spaced apart from a center of the panel hole by a predetermined distance in a third direction perpendicular to both the first direction and the second direction such that the busbar hole does not overlap the panel hole in the second direction.

The busbar assembly may include a busbar guide guiding a flow of cooling fluid passing through the busbar hole.

The busbar assembly may further include an insulating panel disposed between the support plate and the cell assembly, and the busbar guide extends from the busbar into a space between the busbar and the insulating panel.

### BRIEF DESCRIPTION OF DRAWINGS

Predetermined aspects, features, and advantages of the present disclosure are illustrated by the following detailed description with reference to the accompanying drawings.

FIG. 1 is a perspective diagram illustrating a battery module according to an example embodiment of present disclosure;

FIG. 2 is an exploded perspective diagram illustrating a battery module according to an example embodiment of present disclosure;

FIG. 3 is an enlarged diagram illustrating a portion of a cross-section taken along line I-I′ in FIG. 1;

FIG. 4 is a diagram illustrating a flowing direction of cooling fluid in FIG. 3;

FIG. 5 is a diagram illustrating a portion of a cross-section taken along line II-II′ in FIG. 1;

FIG. 6 is an enlarged diagram illustrating A in FIG. 5;

FIG. 7 is an enlarged diagram illustrating B in FIG. 5;

FIG. 8 is an enlarged diagram illustrating a busbar assembly and an end plate according to an example embodiment of present disclosure;

FIG. 9 is an exploded diagram illustrating a busbar assembly according to an example embodiment of present disclosure;

FIG. 10 is a diagram illustrating a state in which cooling fluid passes through a busbar assembly, viewed from above, according to an example embodiment of present disclosure;

FIG. 11A is a diagram illustrating a busbar assembly according to a first embodiment of the present disclosure, viewed from the front, and FIG. 11B is a diagram illustrating a state in which cooling fluid passes through according to the first embodiment, viewed from side surface;

FIG. 12A is a diagram illustrating a busbar assembly according to a second embodiment of the present disclosure, viewed from front, and FIG. 12B is a diagram illustrating a state in which cooling fluid passes through according to the second embodiment, viewed from side surface;

FIG. 13A is a diagram illustrating a busbar assembly according to a third embodiment of the present disclosure, viewed from front, and FIG. 13B is a diagram illustrating a state in which cooling fluid passes through according to the third embodiment, viewed from side surface.

### DETAILED DESCRIPTION

The embodiments of the present disclosure are illustrated in embodiments with reference to the accompanying drawings.

Before starting the detailed description of example embodiments, it should be noted that terms or words used in the descriptions and claims should not be interpreted in a limiting sense.

The same reference numbers or symbols in each drawing represent portions or components performing substantially the same function. For ease of description, the same reference numbers or symbols may be used in different example embodiments.

An expression used in the singular encompasses the expression of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the description below, the terms “upper side,” “upper portion,” “lower side,” “lower portion,” “side surface,” front surface,” and “rear surface,” and the like, are denoted based on the direction in the drawing, and it is noted that the terms may be denoted differently when the direction of the object changes.

The terms “first,” “second,” and the like may be used to distinguish one element from the other, and may not limit a sequence and/or an importance, or others, in relation to the elements. In some cases, a first element may be referred to as a second element, and similarly, a second element may be referred to as a first element without departing from the scope of right in the example embodiments.

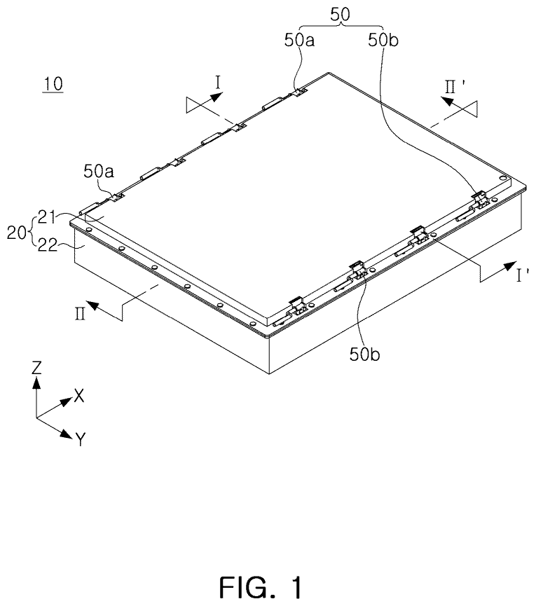

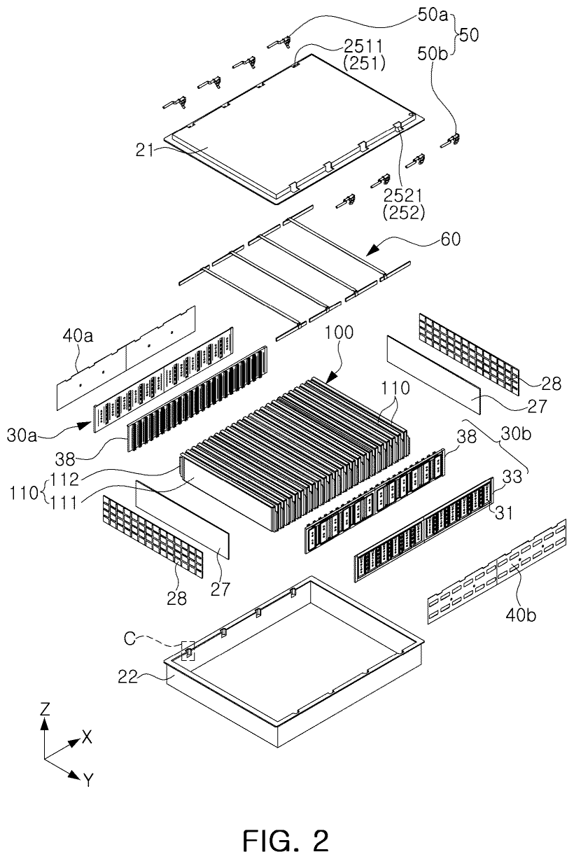

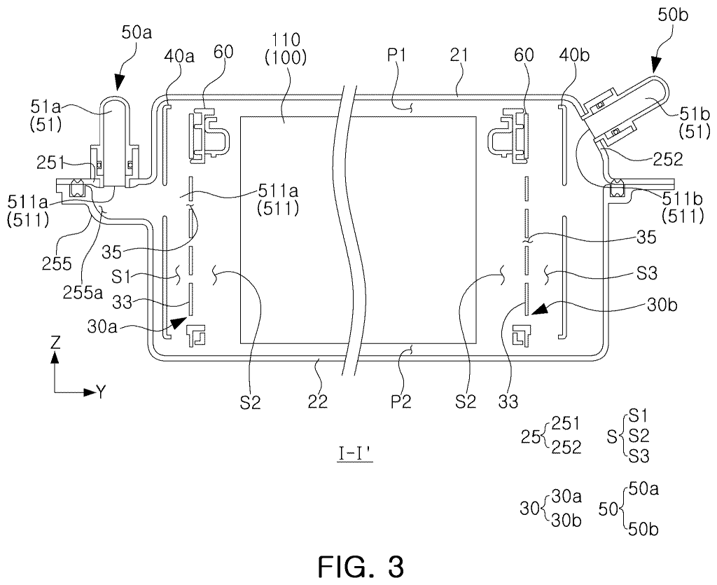

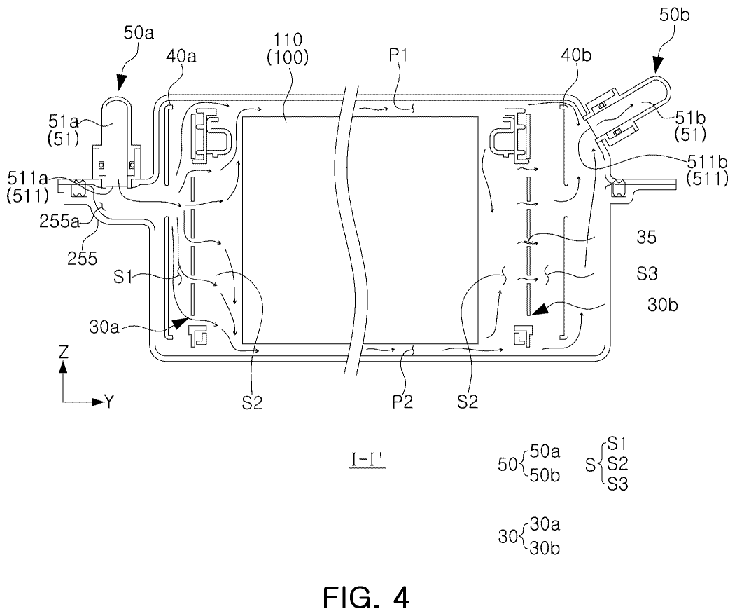

FIG. 1 is a perspective diagram illustrating a battery module according to an example embodiment. FIG. 2 is an exploded perspective diagram illustrating a battery module according to an example embodiment. FIG. 3 is an enlarged diagram illustrating a portion of a cross-section taken along line I-I′ in FIG. 1. FIG. 4 is a diagram illustrating a flowing direction of cooling fluid in FIG. 3.

According to an example embodiment, a battery module 10 may include a housing 20 including an accommodation space S in which cooling fluid is accommodated, a cell assembly 100 disposed in the accommodation space S and including a plurality of battery cells 110 including a lead tab 112, a busbar assembly 30 disposed to face the cell assembly 100 in the accommodation space S and including a busbar 31 electrically connected to the plurality of battery cells 110 and a support plate 33 supporting the busbar 31. Here, according to an example embodiment, the busbar 31 may include a plurality of slit 32 into which the lead tab 112 is inserted, and at least one busbar hole 31h disposed between the plurality of slits 32 and including cooling fluid to enable flow therein.

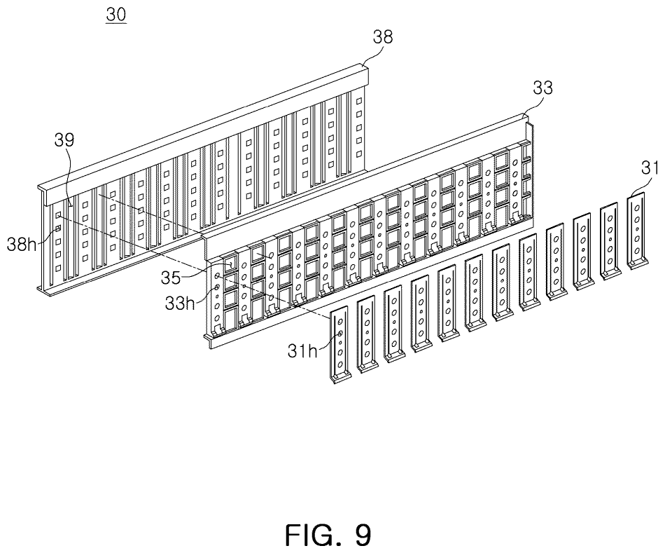

The structure of the busbar hole 31h described above will be described in greater detail later in FIG. 9 and below, and the structure in which cooling fluid flows in the housing 20 will be described first with reference to FIGS. 1 to 4.

According to an example embodiment, the accommodation space S may include a cell assembly 100 accommodated in the accommodation space S and including a plurality of battery cells 110 and a cooling port 50 mounted on the housing 20 and supplying cooling fluid to the accommodation space S or discharging the supplied cooling fluid externally of the housing 20. Also, the cooling port 50 may include an inlet port 50a (“first cooling port”) supplying cooling fluid to the accommodation space S and an outlet port 50b (“second cooling port”) discharging cooling fluid supplied to the accommodation space S externally of the housing 20. Here, the inlet port 50a and the outlet port 50b may be disposed at different levels.

Specifically, the outlet port 50b may be disposed above the inlet port 50a in the direction in which the cooling fluid rises in the accommodation space S (the height direction, or the +Z-axis direction). Accordingly, the relatively substantial amount of the cooling fluid may be accommodated in the accommodation space S.

Here, the notion that “the outlet port 50b is disposed above the inlet port 50a” may be represented from the perspective of the flow of the cooling fluid, and may indicate that the portion 511b (an emit end) into which the cooling fluid of the outlet port 50b flows is disposed above the portion 511a (discharge end) into which the cooling fluid is discharged from the inlet port 50a. Here, “disposed above” may indicate the +Z-axis direction in the drawing or the direction in which the cooling fluid rises in the accommodation space S.

As for the cooling port 50, with respect to the flow of cooling fluid, the component disposed on the upstream side on which the fluid flows in may be referred to as an inlet port 50a (first port), and the component disposed on the downstream side may be referred to as an outlet port 50b (second port). The inlet port 50a and the outlet port 50b may be denoted as above for distinguishing the arrangement positions, and the specific configurations thereof may be the same.

The cooling fluid in the example embodiments may refer to fluid acting as an electrical insulator, such as an insulating oil of which a main component is non-conductive oil. However, the cooling fluid in the example embodiment is not limited thereto, and any fluid having the property of cooling the battery cell 110 through heat exchange with the battery cell 110 may be included.

The housing 20 may include a first cover 21 disposed on the upper side of the cell assembly 100 and a second cover 22 supporting a lower portion of the cell assembly 100. The first cover 21 and the second cover 22 may be coupled to and face each other with the cell assembly 100 interposed therebetween in the height direction (Z-axis direction). The first cover 21 and the second cover 22 may be coupled to each other and may form an accommodation space S therein.

According to an example embodiment, the side plate 27 and the side cover 28 may be disposed in the direction perpendicular to the stacking direction of the cell assembly 100 (the X-axis direction in the drawing). The side plate 27 and the side cover 28 may include an electrically insulating material and may protect the cell assembly 100 from external impacts.

Also, the battery module 10 in the example embodiment may include a busbar assembly 30 disposed so as to face at least one side of the cell assembly 100 and to electrically connect the plurality of battery cells 110 to each other, and a circuit portion 60 connected to the plurality of battery cells 110 and receiving a temperature or current value. The circuit portion 60 may be connected to a battery management system (BMS).

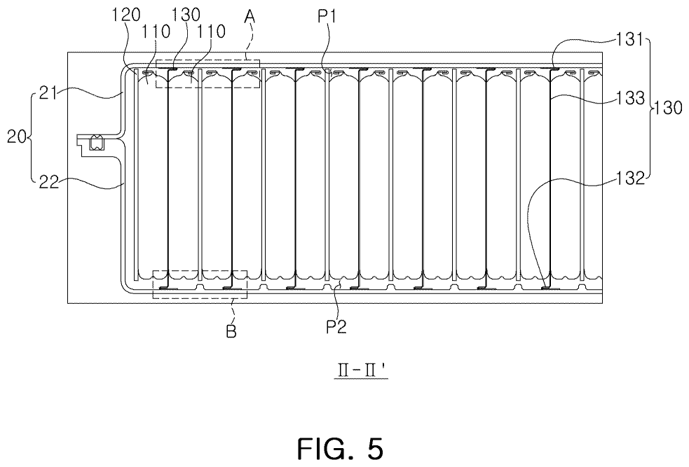

The cell assembly 100 may include the plurality of battery cells 110 stacked in a predetermined direction (e.g., the X-axis direction in the drawing), a plurality of cell pads 120 disposed between the plurality of battery cells 110, and a cooling fin 130 disposed between the plurality of battery cells 110 and the plurality of cell pads 120 and performing cooling (see FIG. 5).

Each of the plurality of battery cells 110 may include a case 111 accommodating an electrode assembly (not illustrated) formed by stacking a positive electrode plate and a negative electrode plate, and a lead tab 112 electrically connected to the electrode assembly and protruding from at least one side of the case 111.

The electrode assembly may be configured such that the positive electrode plate and the negative electrode plate are stacked in a state in which wide surfaces thereof may face each other with a separator interposed therebetween. The separator may be configured to prevent electrical shorting between the positive electrode plate and the negative electrode plate and to generate ion flow. For example, the separator may include a porous polymer film or a porous nonwoven fabric.

Also, the electrode assembly may be a jelly roll type formed by being wound in the predetermined direction, and may be accommodated in the case in various manners, such as a stacking type, a zigzag folding type, a stack-folding type, or the like.

The plurality of battery cells 110 may be a secondary battery of a pouch type, a prismatic type, or a cylindrical type, depending on the structure of the case 111. In the drawing, in the battery cell 110, the case 111 is a pouch cell in the shape of a pouch, but an example embodiment thereof is not limited thereto.

The busbar assembly 30 may include a plurality of busbars 31 electrically connecting the plurality of battery cells 110 to each other and a support plate 33 on which the plurality of busbars 31 are mounted.

In example embodiments, the lead tabs 112 of the battery cells 110 may protrude on both sides in a direction perpendicular to the stack direction (e.g., the Y-axis direction in the drawing), and accordingly, the busbar assembly 30 may be disposed on both sides of the cell assembly 100. In this case, the structures of the first busbar assembly 30a disposed on one side of the cell assembly 100 and the second busbar assembly 30b disposed on the other side may be configured the same and merely the positions thereof may be different.

The example embodiment is not limited to the example in which the busbar assembly 30 is disposed on both sides, and any example in which the busbar assembly 30 is disposed on at least one side may be included in the example embodiment.

The cell pad 120 may be disposed between the plurality of battery cells 110 and may bond or absorb vibration or impact between the plurality of adjacent battery cells 110. For example, the cell pad 120 may include a material having low thermal conductivity and may prevent heat transmission between adjacent battery cells 110. Accordingly, when an abnormal event occurs in one battery cell 110, heat may be prevented from transmitting to adjacent battery cells 110. However, an example embodiment thereof is not limited thereto, and the cell pad 120 may be formed of a material having high thermal conductivity.

The cooling fin 130 may include a material having high thermal conductivity. The cooling fin 130 may be disposed between the plurality of battery cells 110 and may exchange heat with the plurality of adjacent battery cells 110 in contact with each other. The body portion 133 of the cooling fin 130 may be in contact with the case of the battery cell 110 and may exchange heat with the case, and may exchange heat with the cooling fluid through the bent portions 131 and 132 included on both sides ends of the body portion 133 (see FIG. 5).

The busbar 31 may include two or more slits 32 into which the lead tabs 112 of the plurality of battery cells 110 are inserted, respectively. The busbar 31 may electrically connect the electrode terminal, electrically connected to an external power source, to the lead tab 112.

The support plate 33 may support the plurality of busbars 31, and may have a plurality of pass holes 35 through which the cooling fluid flows. A plurality of the pass holes 35 may be included between the plurality of busbars 31 in the vertical direction (e.g., the Z-axis direction in the drawing).

Cooling fluid flowing in through the cooling port 50 may pass through a pass hole 35 and a busbar hole 31h described later and may be in contact with the cell assembly 100.

Also, the busbar assembly 30 may include an insulating panel 38 including an electrical insulating material and into which at least a portion of the battery cell 110 inserted. The insulating panel 38 may include a slit (not illustrated) communicating with the slit 32 of busbar 31 such that the lead tab 112 may pass through insulating panel 38 and may be inserted into the slit 32.

Also, insulating panel 38 may include a panel pass hole 39 (see FIG. 9) communicating with the pass hole 35 of the support plate 33 such that cooling fluid may pass through the busbar assembly 30. The detailed structure of cooling fluid passing through the busbar assembly 30 will be described below with reference to FIG. 9.

As described above, the busbar assembly 30 in the example embodiment may be disposed on both sides of the cell assembly 100. In this case, the first busbar assembly 30a disposed close to the inlet port 50a on one side of the cell assembly 100 and the second busbar assembly 30b disposed close to the outlet port 50b on the other side of the cell assembly 100 may be included. Here, the first and second busbar assemblies 30a and 30b may be denoted as above based on the positions with respect to the cell assembly 100, and the detailed configurations thereof may correspond to each other or may be the same.

When the first and second busbar assemblies 30a and 30b are included as above, the busbar assembly 30 may partition the accommodation space S into a plurality of spaces.

For example, the busbar assembly 30 may be divided into a first space S1 (inset space) between the housing 20 and the first busbar assembly 30a, a second space S2 (loading space) between the first busbar assembly 30a and the second busbar assembly 30b, in which the cell assembly 100 is disposed, and a third space S3 (discharge space) between the second busbar assembly 30b and the housing 20.

Here, the notion of “dividing the accommodation space S into a plurality of spaces” does not indicate physically separating one space from another space such that fluid does not pass therethrough, and the distinction may be made based on the space in which there may be a difference in the flow of fluid between one space and another space.

Referring to FIG. 3, the first space S1 may be a space into which cooling fluid flows in through the inlet port 50a (first cooling port). The second space S2 may be a space in which cooling fluid flows in through at least one of the pass hole 35 of the first busbar assembly 30a or the space between the first busbar assembly 30a and the module housing 20 and in contact with the cell assembly 100, and heat exchange may occur therein. The third space S3 may be a space in which cooling fluid flows in through at least one of the pass hole 35 of the second busbar assembly 30b or the space between the second busbar assembly 30b and the module housing 20 and discharged externally of the module housing 20 through the outlet port 50b (second cooling port).

Based on the flow of cooling fluid, the first space S1 may be disposed on the upstream side, and the third space S3 may be disposed on the downstream side.

Since cooling fluid mainly flows through the pass hole 35 between the first space S1 and the second space S2, and between the second space S2 and the third space S3, the physical characteristics of the fluid, such as the flow rate, may change rapidly.

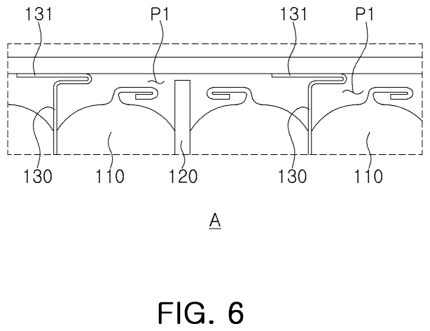

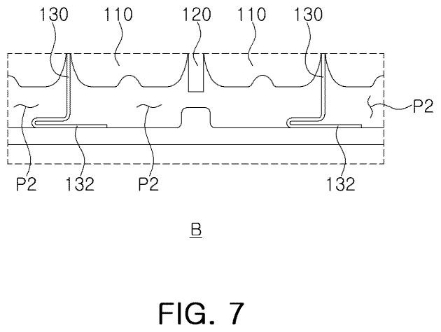

The second space S2 may be a space in which the plurality of battery cells 110 are disposed, and heat exchange may occur between the cooling fluid and the plurality of battery cells 110 in the second space S2. The cooling fluid flowing in into the second space S2 may flow downstream toward the third space S3 through the first flow path P1, which is the space between the cell assembly 100 and the first cover 21, and the second flow path P2, which is the space between the cell assembly 100 and the second cover 22. The first and second flow path P2 will be described in greater detail later with reference to FIGS. 6 and 7.

Referring back to FIG. 3, the housing 20 may include a port mounting portion 25 on which a cooling port 50 is mounted. The port mounting portion 25 may be included in at least one of the first cover 21 and the second cover 22. In the drawing, the port mounting portion 25 may be formed in the first cover 21.

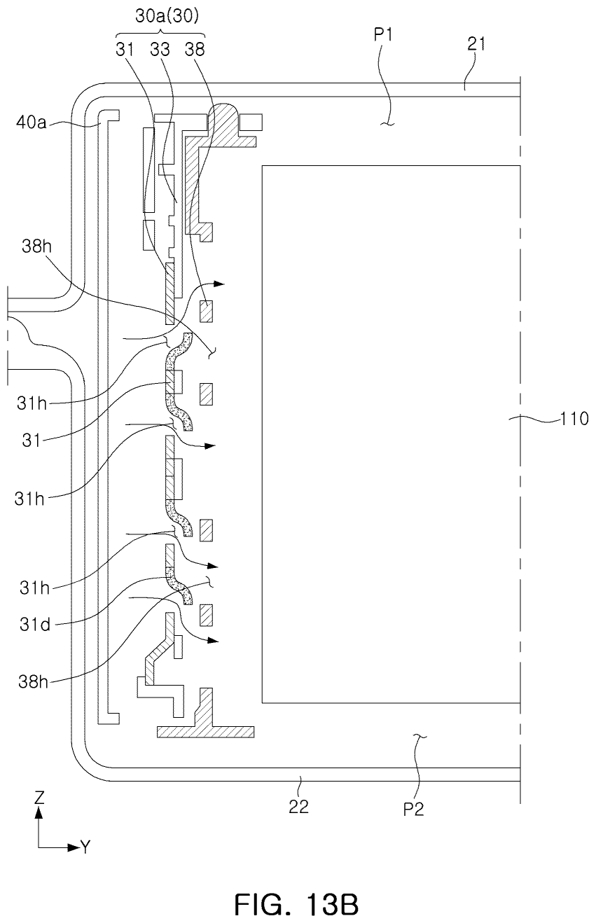

The port mounting portion 25 may include a first port mounting portion 251 on which an inlet port 50a is seated or disposed and a second port mounting portion 252 on which an outlet port 50b is seated or disposed. Each of the first port mounting portion 251 and the second port mounting portion 252 may include a first port hole 2511 and a second port hole 2521. Cooling fluid may be allowed to flow through each of the port mounting portions 251 and 252. In another example embodiment described later, the first port hole 2511 and the second port hole 2521 may be included as holes provided for the hose portion 51 (51a,51b) to be inserted into the housing 20 (see FIG. 13B).

For example, the first and second port holes 2511 and 2521 may be included in a shape in which the first cover 21 penetrates, and the penetration angle may be different depending on the shape of the mounting portion 25. Referring to the drawing, the first port mounting portion 251 may be disposed to face in the vertical direction (Z-axis direction), and the second port mounting portion 252 may be disposed to be inclined. As above, the second port mounting portion 252 on which the outlet port 50b is seated may be disposed to be inclined, such that the cooling fluid may be effectively discharged from the accommodation space S. However, the dispositional angle of the port mounting portion 25 is not limited to the example in the drawing.

Also, as described above, the second port mounting portion 252 may be disposed at a level higher than a level of the first port mounting portion 251. Since the cooling fluid rises upwardly from the lower portion of the accommodation space S, when the second port mounting portion 252 disposed on the downstream side is disposed at a higher level, the flow distance of the cooling fluid may be increased, thereby increasing the opportunity to be in contact with the cell assembly 100. That is, the second port hole 2522 may be disposed at a higher position than the first port hole 2511.

Also, according to the example embodiment, at least one of the first port mounting portion 251 or the second port mounting portion 252 may include a guide portion 255. The guide portion 255 may be formed as a groove in the housing 20 and may form a guide space 255a. The guide portion 255 may be included to guide at least one of the cooling fluid or the hose portion 51 (51a,51b).

Referring to FIG. 3, the guide portion 255 may be disposed to face the first port mounting portion 251 or the inlet port 50a. Through this dispositional structure, referring to FIG. 4, the cooling fluid supplied from the discharge end 511a of the inlet port 50a may be guided to flow toward the cell assembly 100.

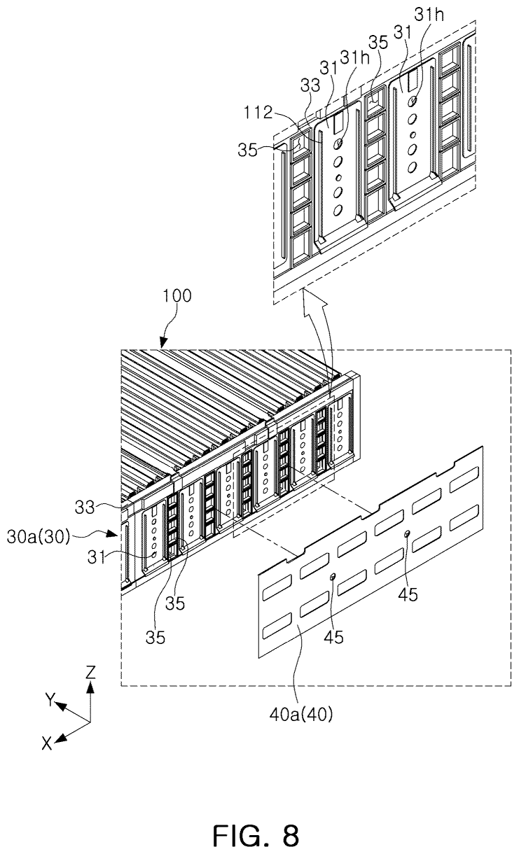

The end plate 40 may include a first end plate 40a facing the first busbar assembly 30a and a second end plate 40b facing the second busbar assembly 30b. The first and second end plates 40a and 40b may have the same main components, and merely the dispositional positions may be different. Each of the first end plate 40a and the second end plate 40b may include a plate hole 45 through which cooling fluid may effectively flow (see FIGS. 2 and 8).

Referring again to FIG. 4, in one example embodiment, cooling fluid flowing in through the discharge end 511a of the inlet port 50a may pass through the plate hole 45 of the first end plate 40a and the pass hole 35 of the first busbar assembly 30a, may enter the second space S2 and may exchange heat with the cell assembly 100. Also, the cooling fluid may pass through the pass hole 35 of the second busbar assembly 30b and the plate hole 45 of the second end plate 40b and may be discharged externally of the accommodation space S through the outlet port 50b.

In FIGS. 3 and 4, both the first end plate 40a and the second end plate 40b may be disposed, but even when only one is disposed or the end plate 40 is not necessarily disposed, the examples may be included in the example embodiment. Even when the end plate 40 is not present, the flowing direction (Y-axis direction) of the cooling fluid flowing from the first to third space S1 to S3 may not be substantially different.

FIG. 5 is a diagram illustrating a portion of a cross-section taken along line II-II′ in FIG. 1. FIG. 6 is an enlarged diagram illustrating A in FIG. 5. FIG. 7 is an enlarged diagram illustrating B in FIG. 5.

Referring to FIG. 5, a first flow path P1, which is a spacing between the cell assembly 100 and the first cover 1, and a second flow path P2, which is a spacing between the cell assembly 100 and the second cover 22, may be formed. As described above, the cooling fluid may flow through at least one of the first flow path P1 and the second flow path P2.

Also, the cooling fin 130 may be in contact with the first cover 21 and the second cover 22 on both sides in the vertical direction, respectively. In this case, the first flow path P1 and the second flow path P2 may be divided into multiple portions by the cooling fin 130. The cooling fin 130 may include the first end portion 131 and the second end portion 132 in contact with the first cover 21 and the second cover 22, respectively.

The above-described structure is merely an example, and the first end portion 131 and the second end portion 132 may not necessarily be in contact with the housing 20. For example, the first end portion 131 and the second end portion 132 may be spaced apart from the housing 20, or may be indirectly in contact with the housing 20 through a separate adhesive.

Referring to FIG. 6, the first end portion 131 may be in contact with the first cover 21 and may divide the first flow path P1 into a plurality of spaces. Also, the first end portion 131 may be bent and the contact region between the cooling fluid and the first cover 21 may increase. Referring to FIG. 7, the second end portion 132 may be in contact with the second cover 22 and may divide the second flow path P2 into a plurality of spaces. Also, the second end portion 132 may be bent and the contact region between the cooling fluid and the second cover 22 may increase.

As above, the first flow path P1 and the second flow path P2 may be divided into a plurality of portions such that the contact area between the cooling fin 130 and the cooling fluid may increase, thereby increasing the cooling efficiency.

FIG. 8 is an enlarged diagram illustrating a busbar assembly and an end plate according to an example embodiment. Referring to FIG. 8, the support plate 33 may include a pass hole 35 through which cooling fluid passes. The pass hole 35 may be disposed between the plurality of busbars 31 such that cooling fluid passes through the support plate 33. In the drawing, the plurality of pass holes 35 may be arranged in the height direction (Z-axis direction), but the example embodiment is not limited to the shape or the number of the pass holes 35.

Also, the first busbar assembly 30a may be disposed to face the first end plate 40a. The first end plate 40a may include a plate hole 45 through which cooling fluid flows.

In the drawing, the first busbar assembly 30a and the first end plate 40a are illustrated, but the above-described structure may also be applied to the second busbar assembly 30b and the second end plate 40b facing the same. In other words, similarly to the first busbar assembly 30a, a pass hole 35 may be included between the plurality of busbars 31 of the second busbar assembly 30b. The pass hole 35 may penetrate the support plate 33 in the second direction (Y-axis direction). Also, the second busbar assembly 30b may be disposed to face the second end plate 40b in the second direction.

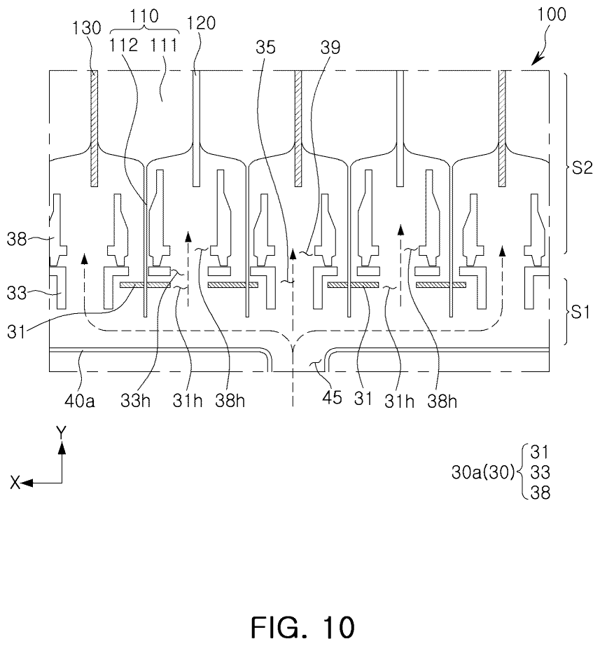

FIG. 9 is an exploded diagram illustrating a busbar assembly according to an example embodiment. FIG. 10 is a diagram illustrating a state in which cooling fluid passes through a busbar assembly, viewed from above, according to an example embodiment.

Referring to FIGS. 9 and 10 together, the busbar assembly 30 in the example embodiment may include a plurality of busbars 31 electrically connected to the battery cell 110, a support plate 33 supporting the plurality of busbars, and an insulating panel 38 coupled to the support plate 33 so as to be disposed between the support plate 33 and the plurality of battery cells 110.

The busbar 31 may include a busbar hole 31h through which cooling fluid passes. The busbar hole 31h may be connected to the support hole 33h and the panel hole 38h, which will be described later, such that cooling fluid may flow.

Also, the busbar hole 31h may be disposed between a plurality of slits 32 into which lead tabs 112 are inserted. Accordingly, cooling fluid may be allowed to flow between adjacent battery cells 110 inserted into one busbar 31.

The area functioning as an electrical connection passage between the plurality of slits 32 may be reduced through the busbar hole 31h. Accordingly, when an overcurrent exceeding a predetermined value flows in the plurality of battery cells 110, the busbar 31 may rupture and may disconnect electrical connection between the plurality of slits 32. That is, the busbar 31 may function as a fuse through the busbar hole 31h.

The support plate 33 may include a support hole 33h communicating with the busbar hole 31h. The support hole 33h may be disposed between the plurality of pass holes 35. Since the busbar 31 is coupled to the support plate 33, the support hole 33h may also be disposed in a corresponding position to communicating with the busbar hole 31h.

The insulating panel 38 may include a panel pass hole 39 communicating with the pass hole 35 and a panel hole 38h communicating with the support hole 33h. The cooling fluid may smoothly pass through the busbar assembly 30 through the busbar hole 31h, the support hole 33h, and the panel hole 38h.

the cooling fluid of the battery module 10 according to the example embodiment may pass through the busbar assembly 30 through two types of communication structures.

More specifically, referring to FIG. 10, the cooling fluid may flow through the pass hole 35 and the panel pass hole 39, or through the busbar hole 31h, the support hole 33h, and the panel hole 38h. Accordingly, the cooling fluid in the battery module 10 may flow smoothly. Also, the panel pass hole 39 and the panel hole 38h of the insulating panel 38 facing the battery cell 110 may be disposed to face between a plurality of battery cells. For example, the panel pass hole 39 and the panel hole 38h may be disposed to face at least one of the cell pad 120 or the cooling fin 130 disposed between the plurality of battery cells 110.

Also, according to the example embodiment, the busbar 31 may be disposed not to face the plate hole 45. In other words, a center of the busbar hole 31h may be spaced apart from the plate hole 45 along the first direction (X-axis direction), so as not to overlap each other in the second direction (Y-axis direction) in which the refrigerant flows. In this case, the plate hole 45 may be disposed to face between the plurality of busbars 31. That is, the plate hole 45 may be disposed so as to not directly face the busbar 31 in the second direction (Y-axis direction) which is the flowing direction of the cooling fluid.

When the busbar 31 faces the plate hole 45 of the first end plate 40 through which the cooling fluid having a relatively low temperature flows, overcooling may occur in the busbar 31 or cooling among the plurality of busbars 31 may not be uniform. Accordingly, in the example embodiment, the busbar 31 may be disposed to not face the plate hole 45. Also, the number of panel holes 38h may be greater than the number of busbar holes 31h.

although not illustrated in the drawing, the flow of the cooling fluid in the second busbar assembly 30b may be opposite to the flowing direction of the cooling fluid in the first busbar assembly 30a described above in FIG. 10. That is, in the second busbar assembly 30, cooling fluid may flow from the second space S2 toward the third space S3.

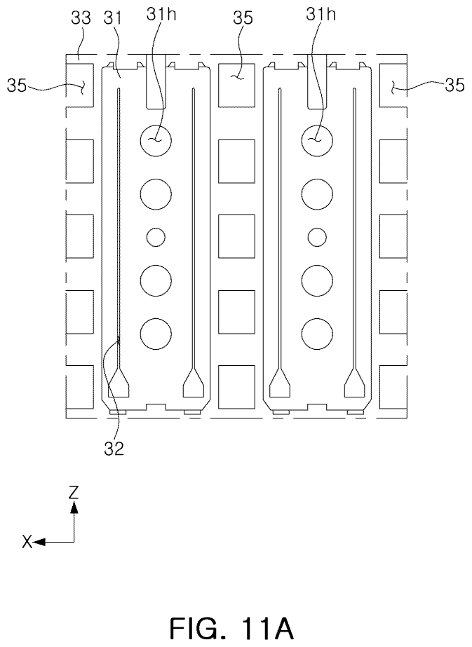

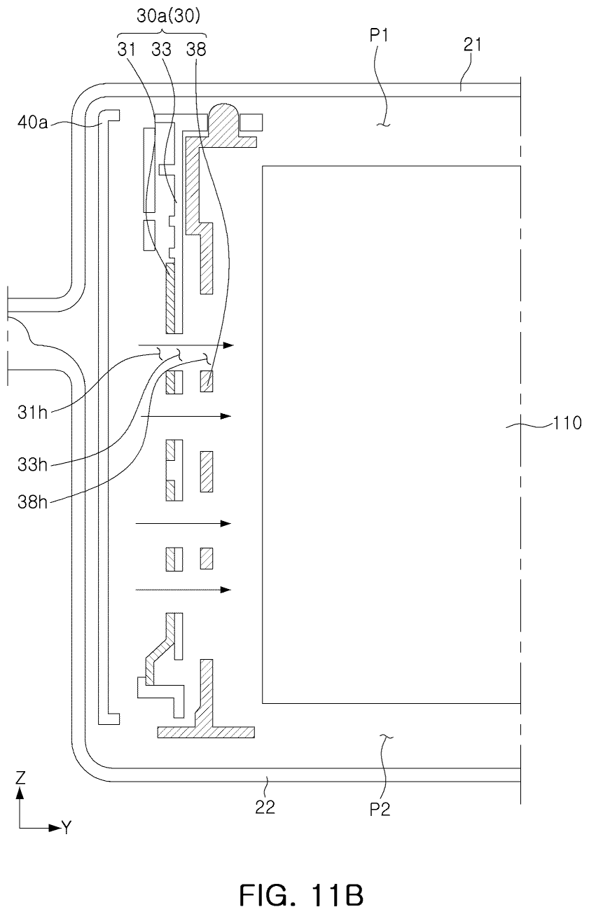

Hereinafter, the hole structure of the busbar assembly 30 will be described in detail with reference to FIG. 11A to 13B. A first embodiment to a third embodiment among a plurality of example embodiments will be described with reference to FIGS. 11 to 13.

FIG. 11A is a diagram illustrating a busbar assembly according to a first embodiment, viewed from front, and FIG. 11B is a diagram illustrating a state in which cooling fluid passes through according to the first embodiment, viewed from side surface.

Referring to FIGS. 11A and 11B together, the busbar assembly according to the first embodiment may have the busbar hole 31h, the support hole 33h, and the panel hole 38h, disposed side by side. Through this structure, the cooling fluid may pass through the busbar assembly 30 smoothly.

Here, the notion of “being disposed side by side” may indicate that the cooling fluid passes through the busbar assembly 30 without hitting a structure such as the support plate 33 or the insulating panel 38.

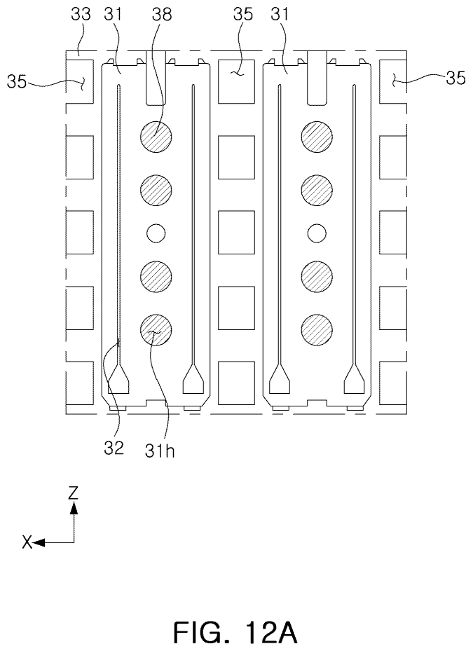

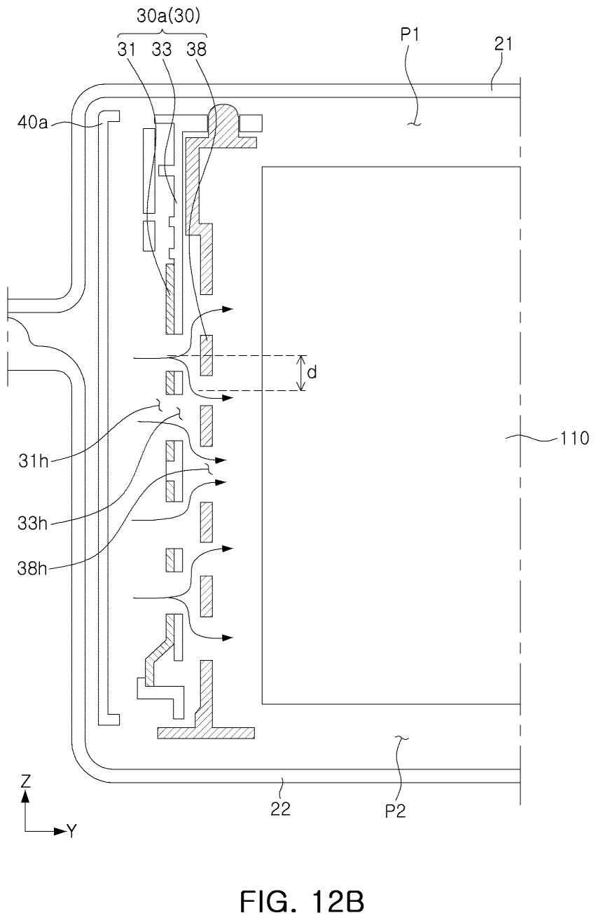

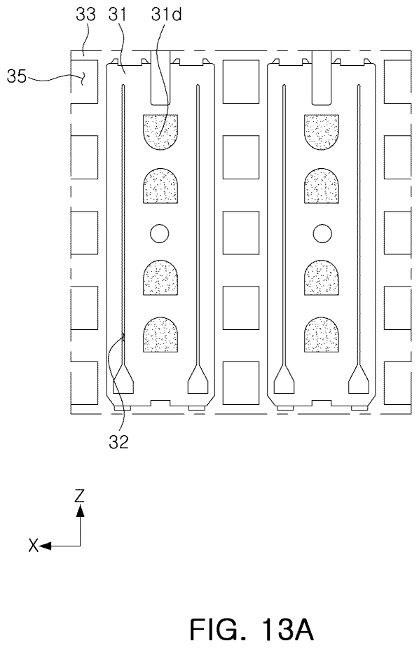

FIG. 12A is a diagram illustrating a busbar assembly according to a second embodiment, viewed from front, and FIG. 12B is a diagram illustrating a state in which cooling fluid passes through according to the second embodiment, viewed from side surface.

Referring to FIGS. 12A and 12B together, in the busbar assembly according to the second embodiment, at least one of the support hole 33h or the panel hole 38h may be disposed not parallel to the busbar hole 31h. As illustrated in the drawing, when the busbar hole 31h and the support hole 33h are disposed parallel to each other but the panel hole 38h is disposed not parallel to each other, the cooling fluid may pass through the busbar hole 31h and the support hole 33h and may hit the insulating panel 38.

In other words, the center of the busbar hole 31h and the center of the panel hole 38h may be spaced apart from each other by a predetermined distance d. Accordingly, a flow path may be formed such that the cooling fluid passing through the busbar hole 31h may hit the panel 38. Accordingly, the cooling fluid may be prevented from being damaged by the flow rate of the cooling fluid and may be further spread.

FIG. 13A is a diagram illustrating a busbar assembly according to a third embodiment, viewed from front, and FIG. 13B is a diagram illustrating a state in which cooling fluid passes through according to the third embodiment, viewed from side surface

Referring to FIGS. 13A and 13B together, the busbar assembly 30 according to the third embodiment may include a busbar guide 31d guiding cooling fluid passing through the busbar hole 31h.

The busbar guide 31d may extend between the busbar 31 and the insulating panel 38 and may guide the flow of cooling fluid.

As illustrated in the drawing, among the busbar guides 31d, the busbar guide 31d bent toward the first cover 21 may guide cooling fluid upwardly, and the busbar guide 31d bent toward the second cover 22 may guide cooling fluid downwardly.

In other words, the busbar guide 31d may be bent toward at least one of the first flow path P1 or the second flow path P2 so as to guide the cooling fluid to at least one of the first flow path P1 or the second flow path P2.

While describing the example embodiment of the busbar assembly 30 in FIGS. 11 to 13, the first busbar assembly 30a is mainly described, but the structure of the first embodiment to the third embodiment described above may also be applied to the second busbar assembly 30b. In other words, the second busbar assembly 30b may have a structure corresponding to the first busbar assembly 30a.

Also, in the example embodiment not illustrated, the first busbar assembly 30a and the second busbar assembly 30b may be included with different structures. For example, the first busbar assembly 30a may have the structure of the second embodiment described above, and the second busbar assembly 30b may have the structure of the first embodiment described above.

According to the aforementioned embodiments, a battery module for preventing a busbar from being overcooled by cooling fluid may be provided.

Also, a battery module which may allow a cooling fluid to smoothly pass through a busbar may be provided.

Only specific examples of implementations of predetermined embodiments are described. Variations, improvements and enhancements of the disclosed embodiments and other embodiments may be made with respect to the disclosure of this patent document.

What is claimed is:

1. A battery module, comprising:
a housing including an accommodation space in which a cooling fluid is accommodated;
a cell assembly including a plurality of battery cells stacked in a first direction in the accommodation space and each including a lead tab; and
a busbar assembly disposed to face the cell assembly in the accommodation space, and including a plurality of busbars electrically connected to the plurality of battery cells, and a support plate supporting the busbar,
wherein the busbar includes:
a plurality of slit holes into which the lead tab is inserted; and
at least one busbar hole disposed between the plurality of slit holes and allowing the cooling fluid to flow therethrough.

2. The battery module of claim 1,
wherein the cell assembly includes at least one of a cell pad disposed between the plurality of battery cells and preventing heat transfer between the plurality of adjacent battery cells or a cooling fin provided to exchange heat with the plurality of adjacent battery cells, and
wherein the busbar hole is disposed to face at least one of the cell pad or the cooling fin.

3. The battery module of claim 1, further comprising:
an end plate disposed to face the cell assembly with the busbar assembly therebetween, and including at least one plate hole through which cooling fluid passes,
wherein a center of the busbar hole is spaced apart from a center of the plate hole by a predetermined distance in the first direction so as to not overlap the plate hole.

4. The battery module of claim 1, wherein the support plate includes at least one pass hole disposed between the plurality of busbars and allowing the cooling fluid to pass therethrough.

5. The battery module of claim 4, further comprising:
an end plate disposed to face the cell assembly with the busbar assembly therebetween, and including at least one plate hole through which cooling fluid passes,
wherein the pass hole is disposed such that at least a portion of the pass hole overlaps the plate hole in the second direction perpendicular to the first direction.

6. The battery module of claim 4, wherein the busbar hole and the pass hole are disposed alternately in the first direction.

7. The battery module of claim 1,
wherein the busbar assembly further includes an insulating panel disposed between the support plate and the cell assembly, and
wherein the insulating panel includes at least one panel hole communicating with the busbar hole in a second direction facing the cell assembly.

8. The battery module of claim 7,
wherein the support plate includes at least one support hole communicating with the busbar hole, and
wherein the support hole is disposed parallel to the busbar hole such that at least a portion of the support hole overlaps the busbar hole in the second direction.

9. The battery module of claim 7, wherein the busbar hole is disposed parallel to the panel hole such that at least a portion of the busbar hole overlaps in the second direction.

10. The battery module of claim 7, wherein the busbar hole is spaced apart from a center of the panel hole by a predetermined distance in a third direction perpendicular to both the first direction and the second direction such that the busbar hole does not overlap the panel hole in the second direction.

11. The battery module of claim 1, wherein the busbar assembly includes a busbar guide guiding a flow of cooling fluid passing through the busbar hole.

12. The battery module of claim 11,
wherein the busbar assembly further includes an insulating panel disposed between the support plate and the cell assembly, and
wherein the busbar guide extends from the busbar into a space between the busbar and the insulating panel.
